(19) United States
(12) Patent Application Publication
(10) Pub. No.: US 2011/0192754 A1
(43) Pub. Date: Aug. 11, 2011

(54) METHOD FOR GUIDED TEARING OF POUCH LAMINATE TO ENABLE PRODUCT REMOVAL

(75) Inventors: Greg Slominski, Valparaiso, IN (US); Beuford A. Bogue, New Carlisle, IN (US); Madhu Hariharan, Munster, IN (US); Kurt Easton, Hobart, IN (US); Theodore Clemente, JR., Warren, NJ (US)

(73) Assignee: MONOSOL RX, LLC, Warren, NJ (US)

(21) Appl. No.: 12/702,668

(22) Filed: Feb. 9, 2010

(51) Int. Cl. B65D 73/00; B65D 51/00; B31B 1/25

(52) U.S. Cl. 206/484; 220/266; 493/228

(57) ABSTRACT

The present invention provides a safe and effective package for housing a dosage, which is easily opened by a user yet provides a secure and contaminant-free environment for the dosage housed within. The package may include a guided tear condition extending along at least one edge of the package, allowing a user to safely and effectively open the package without risk of compromising the dosage housed therein. In some embodiments, the dosage is a substantially flat dosage, such as a film.

### FIELD OF THE INVENTION

The present invention relates to packages for dispensing dosages, including pharmaceutical dosages that deliver drugs and bioactive materials. More particularly, the present invention relates to packages that are easily opened and capable of dispensing the dosage with lessened risk of compromising the integrity of the dosage.

### BACKGROUND OF THE INVENTION

Various packages have evolved in the field of packaging, including blister packs and notched tear open packages. These designs are not ideal for housing single dose film products, in part due to the likelihood of tearing or otherwise compromising the film housed within the package. In addition, many packages are neither child resistant nor user friendly. Though these technologies easily indicated the method of opening the package, users with limited grip or hand strength had difficulty in gripping the thin, laminated notched area or prying open blister packs.

Previous attempts to develop a more beneficial packaging for films have fallen short. Some previous attempts have provided a tear notch at one corner of the package, allowing the user to begin tearing the package to open it. However, often, the tear will veer off to one side, insufficiently opening the package, requiring the user to pick and tear at the pouch to finish opening the product. This often results in a great degree of frustration, and may even result in the user simply giving up and throwing the package away, thereby wasting the pharmaceutical product housed therein. In other situations, the tear may veer off into the center of the package, often tearing the product inside, as well as the package. Other previous attempts have required the combination of a tearable portion as well as a peelable seal between layers of the package.

Peelable packages suffer from defects as well, since peeling often requires the user to flex and manipulate the package in order to peel the layers away. In this instance, the film is much more likely to break when it is flexed and deformed upon exiting the package. Thus, portions of the dosage may be contaminated or lost entirely. In addition, this requires that the user must have adequate sight, grip, and dexterity to grip the individual, thin layers of the first and second layers of the packaging, peel the layers apart, and retrieve the film from within before it falls out. Often, users may have ailments or limitations in their grip, grasp, and dexterity that prevents such accuracy and precision in opening a single dose of a pharmaceutical product once, let alone repeated opening of a series of single doses over time, as with a prescribed usage.

In other attempts, the package includes perforations in the package that go through all layers of the package. The use of perforations throughout the entire package may compromise the seal provided by the package, allowing contaminants to enter the package and destroy the integrity of the dosage. In addition, perforations through the entire product may result in an unintended premature package opening, which may in turn result in contamination and compromised integrity of the drug dose. Furthermore, such packages may be more readily opened by children, resulting in undesirable access and accidental poisoning.

Thus, the present invention seeks to solve the problems of the prior attempts at packaging, including by providing a secure, sealed package that is easily tearable along a guided pathway to allow efficient and secure delivery of the dosage contained therein.

### SUMMARY OF THE INVENTION

In one embodiment of the present invention, there is provided a tearable package for a dosage form including: a first layer having a first inside layer and a first outside layer, the first inside layer including a first protective material and the first outside layer including a first laminate material; a second layer having a second inside layer and a second outside layer, the second inside layer including a second protective material and the second outside layer including a second laminate material; and a guided tear condition along a portion of at least one edge of the first outside layer; the first and second layers being overlaid with each other such that the first protective material and the second protective material are in contact and sealed together at a perimetrical sealing region, the fused layers defining a compartment therebetween for housing a dosage form.

In another embodiment of the present invention, there is provided a method of forming a tearable package, including the steps of: providing a first layer having a first inside layer and a first outside layer, the first inside layer including a first protective material and the first outside layer including a first laminate material; providing a second layer having a second inside layer and a second outside layer, the second inside layer including a second protective material and the second outside layer including a second laminate material; and; overlaying the first and second layers with each other such that the first protective material and the second protective material are in communication with each other; sealing the first and second layers together at a perimetrical sealing region, the sealed layers defining a compartment therebetween for housing a dosage form; and forming a guided tear condition along a portion of at least one edge of the first outside layer.

### BRIEF DESCRIPTION OF THE DRAWINGS

The present invention may be better understood through reference to the Figures, which are intended to be illustrative and are not drawn to scale.

FIG. 1 is a perspective view of one embodiment of the package layers of the present invention.

FIG. 1A is a side view of the embodiment of FIG. 1.

FIG. 2 is a top plan view of an embodiment of the present invention.

FIG. 3 is a cut-away side view across the axis of FIG. 2.

FIG. 4 depicts a perspective opened view of an embodiment of the present invention.

FIG. 5 is an alternate embodiment of the present invention, including a guided tear line along more than one edge of the package.

FIG. 5A depicts the package of FIG. 5, after a user has torn along the guided tear lines.

FIG. 6 is a close up view of an embodiment of the present invention including a guided tear condition.

FIG. 7 is a flowchart of a method of forming the inventive package.

### DETAILED DESCRIPTION OF THE INVENTION

Film systems embody a field of technology that has major advantages in areas of administering drug, medicament, and various other active and agent delivery systems to an individual in need thereof. It will be understood that the term “film” includes delivery systems of any thickness or size, including films, sheets, discs, wafers, and the like, in any shape, including rectangular, square, or other desired shape. The film may be in the form of a continuous roll of film or may be sized to a desired length and width. The films described herein may be any desired thickness and size suitable for the intended use. For example, a film of the present invention may be sized such that it may be placed into the oral cavity of the user. Other films may be sized for application to the skin of the user, i.e., a topical use. For example, some films may have a relatively thin thickness of from about 0.1 to about 10 mils, while others may have a somewhat thicker thickness of from about 10 to about 30 mils. For some films, especially those intended for topical use or longer term oral use, the thickness may be even greater, i.e., greater than about 30 mils. In addition, the term “film” includes single-layer compositions as well as multi-layer compositions, such as laminated films, coatings on films and the like. The composition in its dried film form maintains a uniform distribution of components through the application of controlled drying of the film. Films may include a pouch or region of medicament between two films.

In some embodiments of the invention, the films are intended for oral administration. In other embodiments, the films are intended for topical administration. As used herein, the term “topical agent” is meant to encompass active agents that are applied to a particular surface area. For example, in one embodiment, a topical agent is applied to an area of the skin. In other embodiments, the topical agent may also be applied to mucosal areas of the body, such as the oral (e.g., buccal, sublingual, tongue), vaginal, ocular and anal areas of the body. In other embodiments, a topical agent is applied to a hard surface, such as a particular surface area in need of treatment.

Various methods of forming uniform films, as well as various additives and fillers, may be used, including those methods and materials described in U.S. Pat. Nos. 7,425,292 and 7,357,891 and U.S. Publication No. 2005/0037055, which are herein incorporated by reference in their entireties.

As the technology related to film dosages has developed to include pharmaceutical delivery systems, the desire remains to store the pharmaceutical securely away from children, while employing an accessible packaging for adult users. It may be especially important to allow an accessible package to users with limited hand strength, grip, or dexterity, such as may be found in the elderly. The complex and reactive ingredients of pharmaceuticals requires packaging with specific resistance against contamination, reaction, or degradation of the compound so as to promote a longer shelf-life and, perhaps more importantly, to comply with global regulations and requirements set forth by regulatory bodies.

Single-dose packaging has been developed in order to reduce contamination or accidental overdose with respect to film dosages including pharmaceuticals. The various embodiments of the present invention provide new and useful applications in the field of packaging technology, in which the various embodiments efficiently and effectively overcome the shortcomings of previous technology as used in the packaging of film dosages. The present package is effective in storing and stabilizing the film dosage and also will resist contamination, yet may be opened by individuals in such a fashion that it maintains the integrity of the composition and its sensitive components.

With reference to the Figures, a tearable package 10 is shown. The present invention provides embodiments of a tearable package 10, which may accommodate a pharmaceutical product, but it is understood that products lacking pharmaceuticals, drugs, or bioactive actives may be included in the present package. The present invention provides an embodiment of methods for manufacturing a tearable package of the present invention. The tearable package 10 may be a substantially flat package, or it may have raised or bubbled portions. For ease of explanation, reference will be made to a substantially flat package, which is especially useful in housing a flat dosage form (such as a film), but it will be understood that other materials may be housed within the package.

In one preferred embodiment, the package 10 of the present invention includes two layers: a first layer 12 and a second layer 14. In a most desirable embodiment, the first and second layers 12, 14 are rectangular in shape, however it will be understood that any desired shapes may be incorporated into the present invention, including square, circular, oval, diamond, or any other desired shape. In one embodiment, the first layer 12 may have first and second longitudinal edges 16, and first and second lateral edges 18. Similarly, the second layer 14 may have first and second longitudinal edges 16′, and first and second lateral edges 18′. Desirably, the first and second layers 12, 14 are substantially flat, and are sized to approximately the same length and width. However, the first layer 12 may be longer, shorter, wider, or less wide than the second layer 14. Having one layer shorter than the other may provide benefits in that the user may more easily grip and tear the package.

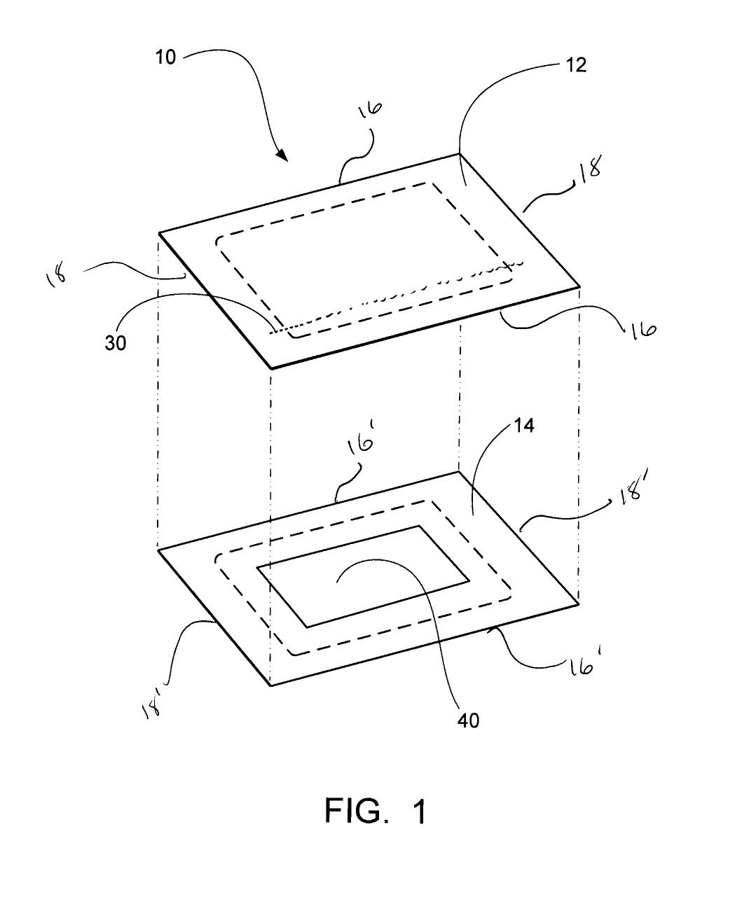

As depicted in FIG. 1, the first and second layers 12, 14 may be aligned such that their longitudinal edges 16, 16′ and lateral edges 18, 18′ respectively are substantially aligned. In this fashion, the two layers 12, 14 may be joined together to form a housing for a dosage 40, which is to be housed therein. As will be described in more detail below, the package 10 includes a sealed region joining the first and second layers 12, 14, which houses the dosage 40 therein. The first layer 12, the second layer 14, or both layers 12, 14 may include a guided tear line 30 along a portion of one of its edges. As seen in FIG. 1, the guided tear line 30 may be disposed along one longitudinal edge 16, however, it is understood that the guided tear line may be disposed along one of the lateral edges 18 as well. A guided tear line 30 may thus be disposed on any or all edges of the package. The guided tear line 30 preferably extends along at least a portion of a peripheral edge. In some embodiments, the guided tear line 30 may extend along at least a majority of a peripheral edge. For example, in some embodiments, the guided tear line 30 may extend about 20% the length of the edge; while in others, the guided tear line 30 may extend about 40% the length of the edge. In still other embodiments, the guided tear line 30 may extend about 50% the length of the edge; and other embodiments, the guided tear line 30 may extend about 60% the length of the edge. Desirably, the guided tear line extends at least 25% of the length of the edge or at least 50% of the length of the edge.

FIG. 1A is a side view of the first and second layers 12, 14, prior to joining the layers to form a package 10. In one preferred embodiment, the first layer 12 and the second layer 14 are each multi-layered sheets. In this embodiment, the first layer 12 includes a first outer layer 20 and a first inner layer 22. Similarly, in this embodiment, the second layer 14 includes a second inner layer 24 and a second outer layer 26. The first and second layers 12, 14 may include various other intermediate layers as desired to achieve the final product. The first outer layer 20 and first inner layer 22 are desirably contiguous with each other, as are the second outer layer 24 and second inner layer 26. The multi-layered sheets forming the first layer 12 and second layer 14 may be made via any known process, including laminating, using adhesives, mechanically crimping, or a combination of these methods. Lamination is typically accomplished with heat and pressure to seal the layers at specific areas, but any lamination method may be used as desired.

In one particular embodiment, the first layer 12 and the second layer 14 may be one continuous layer. In this embodiment, the continuous layer may be folded over itself, such that the first layer 12 and the second layer 14 are layered on top of each other such that their longitudinal edges 16, 16′ and lateral edges 18, 18′ are substantially aligned, forming the package. In this fashion, only three of the edges would need to be sealed, since the fourth edge is formed via folding. If desired, however, the fourth edge may be sealed as well.

Preferably, the first inner layer 22 and the second inner layer 24 are made from the same or similar materials. In a preferred embodiment, the first inner layer 22 and second inner layer 24 include foil-type materials. Foil type materials have been shown to provide a secure and contaminant-free housing for dosages. Materials suitable for forming the first and second inner layers 22, 24 include plastics, foils, and combinations thereof. In one particularly useful embodiment, the first and second inner layers 22, 24, may be made from a foil material, such as aluminum foil. Other similar materials may be used as desired. As will be described in more detail below, the first inner layer 22 and second inner layer 24 should be capable of being sealed to each other, through any desired sealing means. For example, the first and second inner layers 22, 24 may be treated with a material to enhance their sealing characteristics. Sealing may include any sealing methods desired, for example, chemical sealing, pressure sealing, thermal sealing, ultrasonic sealing, or combinations thereof.

The first outer layer 20 and second outer layer 26 are likewise preferably made from the same or similar materials, however, these layers may be made from different materials if desired. Preferably, the first and second outer layers 20, 26 are made from a laminate material, such as plastic. In particular, the material may include polyester, polyethylene terephthalate (PET), modified polyethylene terephthalate (PETG), polyethylene (PE), low density polyethylene (LDPE), linear low density polyethylene (LLDPE), medium density polyethylene (MDPE), high density polyethylene (HDPE), metallocene-catalyzed polyethylene copolymer resins (mPE), polypropylene (PP), oriented polypropylene (OPP), biaxially oriented polypropylene (BOPP), metalized cast polypropylene (MCPP), poly vinyl chloride (PVC), thermoplastic polyurethane (TPU), and ethylene-vinyl acetate (EVA), ethylene (PCTFE), and combinations thereof. Desirably, the laminate material is capable of being flexed, while maintaining its integrity and shape. Further, to enhance the child-resistant nature of the package, the laminate material is most preferably difficult to tear without first providing a tear-promoting surface condition, such as a tear notch. In one particularly useful embodiment, the first layer 12 and/or second layer 14 is made from a laminated foil material, including that sold under the trade name RFE 042, sold by Amcor Flexibles, which is a polyester laminated aluminum foil. Thus, the first or second inner layer (22, 24) would be made from aluminum foil, and the first or second outer layers (20, 26) would be made from the polyester laminate. The material may have a polyester portion that is either clear or colored, or it may have both clear and colored polyester portions.

For example, when the package 10 is made from the aforementioned polyester/aluminum material sold under the trade name RFE 042, sold by Amcor Flexibles, the seal strength is such that it will be destroyed (i.e., torn or ripped) upon attempt to separate the layers. The laminate material should further be capable of withstanding heat and moisture, thereby further protecting the dosage 40 housed in the package 10. Finally, the laminate material may be capable of having indicia printed thereon.

In one embodiment, at least one of the first or second layers 12, 14 may be made from a clear material, such as a clear plastic material. In this embodiment, when the package 10 is formed, the contents inside the package may be viewable to an observer without having to open the package 10.

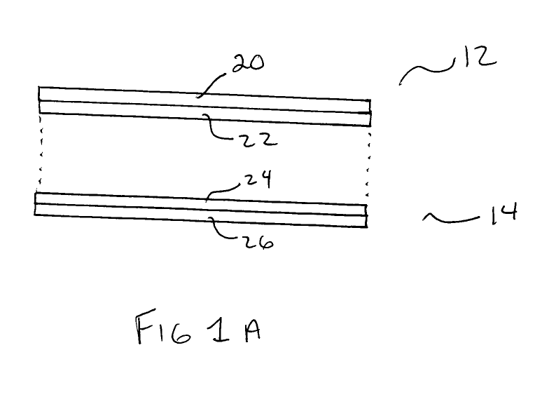

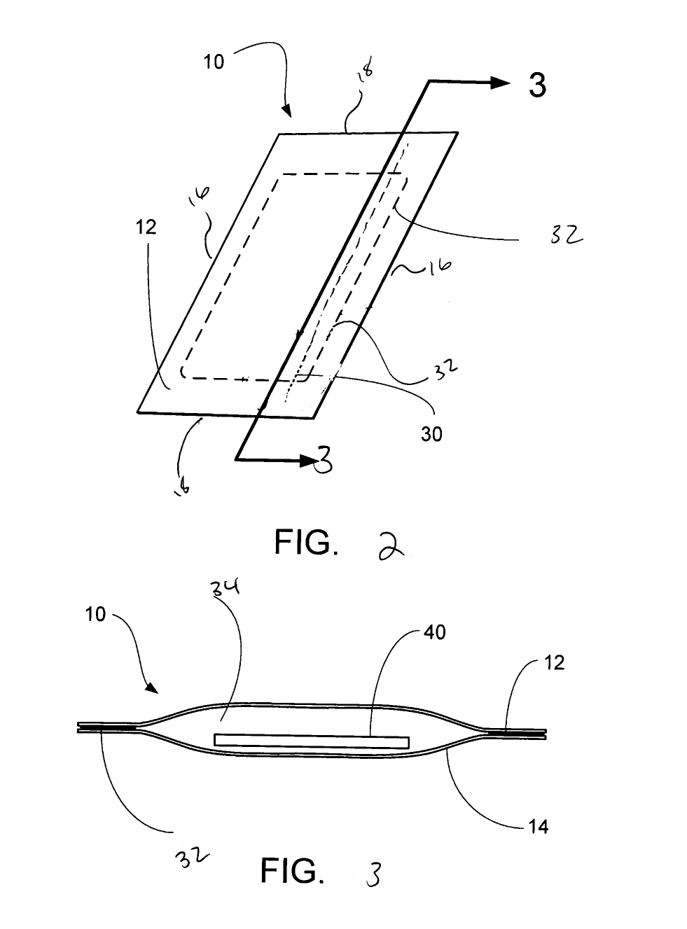

FIG. 2 depicts one embodiment of the package 10, after the first layer 12 and second layer 14 (not seen) have been aligned and sealed together. Sealing area 32 is depicted, which represents the area where the first layer 12 and the second layer 14 are joined to each other. As can be seen, sealing area 32 preferably extends around the periphery of the package 10, but it will be understood that the sealing area 32 can be disposed at other locations of the package 10, not necessarily about the entire periphery of the package 10. The sealing area 32 may be as thick or thin as necessary to create an air tight, moisture tight, and tear-resistant seal between first and second layers 12, 14. As can best be seen in FIG. 3, the sealing area 32 creates a pocket or compartment 34 between the first and second layers 12, 14. The compartment 34 should be sized appropriately to house a dosage 40 therein. In some embodiments, it may be desirable that the compartment 34 is larger than the dosage 40. Further, it is most preferred that the sealing area 32 be a secure, non-peelable seal, which further reduces the likelihood that the first and second layers 12,14 are unintentionally separated. In addition, the use of a non-peelable seal creates a safer and more secure, contaminant-free compartment 34 for the dosage 40.

In one embodiment, the guided tear line 30 extends along at least one of the edges of the first layer 12. Desirably, the guided tear line 30 extends along at least a majority of at least one of the edges of the first layer 12, however, the guided tear line 30 may extend along at least one of the edges of the first layer 12 less than half the length of the edge. Desirably, the guided tear line 30 extends into the compartment 34 formed by the sealing area 32, as best seen in FIG. 2. In such a fashion, the user may tear the package 10 along the guided tear line 30, thereby opening one side of compartment 34, and exposing the dosage 40 housed therein. It is preferred that the compartment 34 be sized larger than the size of the dosage 40, to enable the user to tear along the guided tear line 30 without tearing or otherwise compromising the dosage 40. The guided tear line 30 may be any size or shape desired, and further may include indicia indicating its location on the package 10. Desirably, the guided tear line 30 is linear, but may be curved if desired. In some embodiments, after the tear has reached one end of the long edge, the guided tear line may curve in such a way as to redirect the tear along a second edge of the rectangular package in a single tearing motion causing two exposed open edges allowing easier access to the product inside the package.

Previous attempts at packaging included only a notch or other small surface condition at one end of the package, most commonly in or near one corner of the package. Thus, the user was required to tear the package carefully, so as to avoid unintentionally tearing into the compartment where the dosage was held. Tearing into the compartment may compromise the dosage held inside, such as by ripping the dosage in pieces or causing the dosage to fall out of the package prematurely. The use of a guided tear line 30 provided in the present invention allows a user to perform a controlled tear along one edge of the package 10, tearing into the compartment 34 in a controlled manner so as to reduce or altogether eliminate the possibility of tearing the dosage 40 housed therein. The package 10 may include a tear notch at one end of the package 10, as is known in the art. In some embodiments, the guided tear line 30 may begin at or near one edge of the package 10, thereby acting as a tear notch and allowing a user to begin the tear of the package 10. The package 10 may include other safety features, such as a fold line, requiring the user to first fold the package 10 prior to tearing, as described in Applicant's co-pending patent application U.S. application Ser. No. 12/409,972, filed Mar. 24, 2009 entitled “Tearable Packages For Pharmaceutical Product And Method”, the contents of which are incorporated herein in their entirety.

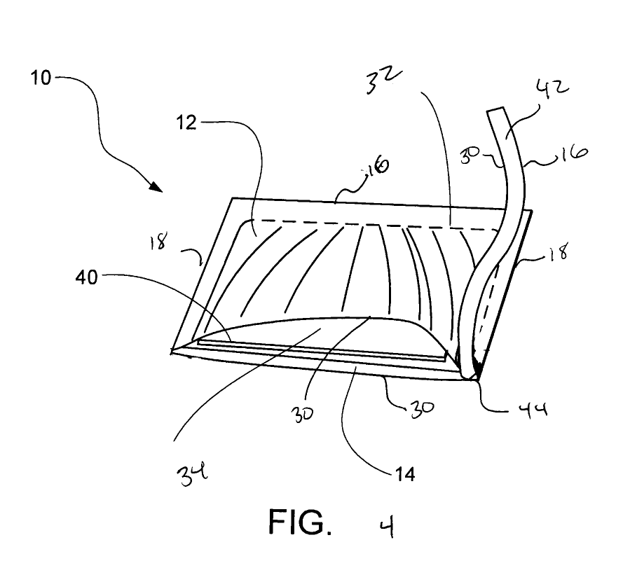

The package 10 of the present invention allows the user to perform a guided tear along one edge of the package 10, into the compartment 34, which allows for easy and safe release of the dosage housed therein 40. As can be seen in FIG. 4, after the user has torn the package 10 along at least a majority of the guided tear line 30, the dosage 40 housed therein is revealed and can be removed by the user. After tearing, the torn section 42 of the package 10 may either be completely removed from the package 10 or may remain attached at one corner 44. In either way, the package 10 is sufficiently opened such that the dosage 40 may be easily removed by the user without risk of breaking or compromising the dosage 40. Further, as can be seen, the torn section 42 is substantially straight along the longitudinal edge 16 of the package 10, further reducing the risk of compromising the dosage 40 housed therein. No additional separation of layers 12, 14 is required to release the dosage 40.

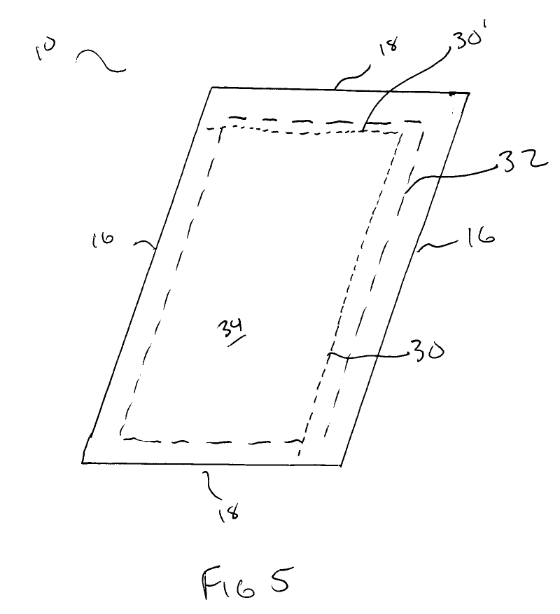

In another embodiment, depicted in FIG. 5, the guided tear line 30 may extend substantially along more than one edge of the package 10. In this embodiment, for example, the package 10 is provided as described above, with a sealed area 32 defining the compartment in which the dosage is housed. A guided tear line 30 may begin by extending along a portion of a longitudinal edge 16, and a second guided tear line 30′ may extend along a portion of a lateral edge 18. In some embodiments, the guided tear line 30 and second guided tear line 30′ may intersect each other. Desirably, both the guided tear line 30 and the second guided tear line 30′ at least partially extend into the compartment 34 formed by the sealing area 32.

In this embodiment, as can best be seen in FIG. 5A, the user may tear along the guided tear line 30 and the second guided tear line 30′, revealing more of the compartment 34, and allowing an even easier removal of the dosage 40 housed therein. Again, the torn away section 42 may be completely removed from the package 10 or it may be left attached at one corner. In this embodiment, there is even less risk of compromising or tearing the dosage 40, since the compartment 34 has been opened to a greater degree, and the top layer 12 can be lifted away from the dosage 40, allowing for easy removal of the dosage 40. Further, since the guided tear line 30 and second guided tear line 30′ extend along a portion of the longitudinal edge 16 and lateral edge 18 within the compartment 34, there is lessened risk of inadvertent tearing of the package 10 into the dosage 40.

The guided tear line 30 (as well as the second guided tear line 30′) may include any feature that allows the user to tear the package 10 at a specific location along at least one edge of the package 10, and desirably along a majority of at least one edge of the package 10. In one desired embodiment, the guided tear line 30 may include a series of perforations, indentations, deformations or scorings extending along a portion of at least one edge of the package 10. However, as explained above, it is important that any perforations, indentations, deformations or scorings 50 not extend through all layers of the package laminate, since the compartment 34 of the package 10 must be fully sealed. Including perforations, indentations, deformations, scorings or other guided tear promoting conditions, which extend through the entire package will run the risk of allowing contaminants to enter the compartment 34, and ruin the integrity of the dosage 40. Thus, the guided tear line 30, as will be described in further detail below, desirably extends only partially through the thickness of the package 10, and more desirably does not extend through the first or second inner layers 22, 24.

The guided tear line 30 desirably is formed such that the first inner layer 22 and the second inner layer 24 are unmodified, most desirably in such a fashion that the first inner layer 22 and second inner layer 24 have no holes or weakened areas. As explained above, the first and second inner layers 22, 24 form the protective layers of the compartment 34 formed by the sealing area 32 of the package 10. Thus, maintaining the integrity of the first and second inner layers 22, 24 is important to protect the dosage 40.

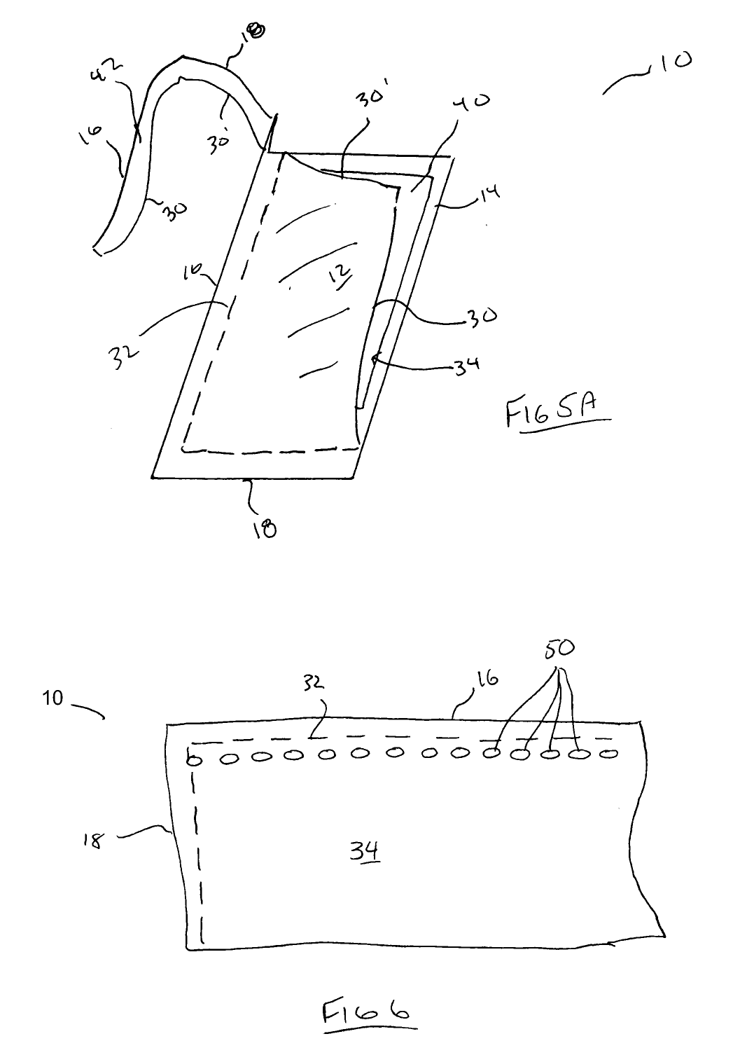

The present applicants have discovered that a guided tear line 30 may be created in only the outside layers (i.e., first outside layer 20 and/or second outside layer 26), thereby allowing a guided tear line 30 which does not compromise the first and second inner layers 22, 24. The guided tear line 30 may include any features that allow for a guided tear, including but not limited to a series of perforations, indentations, deformations, scorings, a series of weakened areas, and combinations thereof. As used herein, the term “weakened areas” will generally refer to holes, perforations, scored areas, thinned material, or other feature that will allow the user to tear the layer at the weakened areas. As may be seen in FIG. 6, the package 10 may include a series of weakened areas 50, extending along a portion of at least one edge (in this embodiment, the longitudinal edge 16) of the package 10. The weakened areas 50 most desirably are formed only in the laminate layer (including the first outside layer 20, the second outside layer 26, or both the first and second outside layers 20, 26), thereby not harming or modifying the inner layers (first and second inner layers 22, 24). In some embodiments, the inner layer 22 may be visible through the holes formed by the perforations, indentations, deformations or scorings 50. The weakened areas 50 may be any length or shape, including straight lines, curved lines, rectangular shapes, oval shapes, circular shapes, or any desired shape. In some embodiments, the weakened areas 50 may include a thin section of at least one of the first or second outside layer 20, 26, such that no holes are punctured through the layer (20, 26), but a user can tear the layer (20, 26) at the location of the weakened area 50.

If desired, the weakened areas 50 may be made to the inside surface of the first outside layer 20, the second outside layer 26, or both the first and second outside layers 20, 26. In this fashion, the weakened areas 50 will not be visible on the outside of the package 10, where they may interfere with any artwork, writing, or other indicia on the package 10. Further, indicia may be provided that indicate the location of the guided tear line 30, if desired.

In one embodiment, a laser may be used to create weakened areas 50 in the first outside layer 20 and/or second outside layer 26 of the package 10. In some embodiments, the laser may be a laser-printing device, including laser-printing devices that are known to print information on packages, including lot code and expirations dates. The present applicants have discovered that such laser printing devices may be tasked to “print” a series of dashes or holes along a portion of at least one edge of the package 10, creating a guided tear line 30 along which the user may safely and effectively tear the package 10 open. This creates a series of weakened areas 50 only through the laminate layer of the package 10. The tear direction can be managed such that at least a portion of the edge of the package 10 can easily be opened by the user, exposing the dosage 40 therein.

If desired, the guided tear line 30 may be disposed on the first layer 12 of the package 10, or it may be disposed on the second layer 14 of the package 10. In some embodiments, there may be a guided tear line 30 on both the first layer 12 and the second layer 14, at approximately the same location on the package 10. The use of a guided tear line 30 on both the first and second layers 12, 14 may allow even more control and guidance to the user when tearing the package 10 open. In any case, the first and second inner layers 22, 24 should remain intact, providing a sufficient and effective sealing layer for the dosage 40.

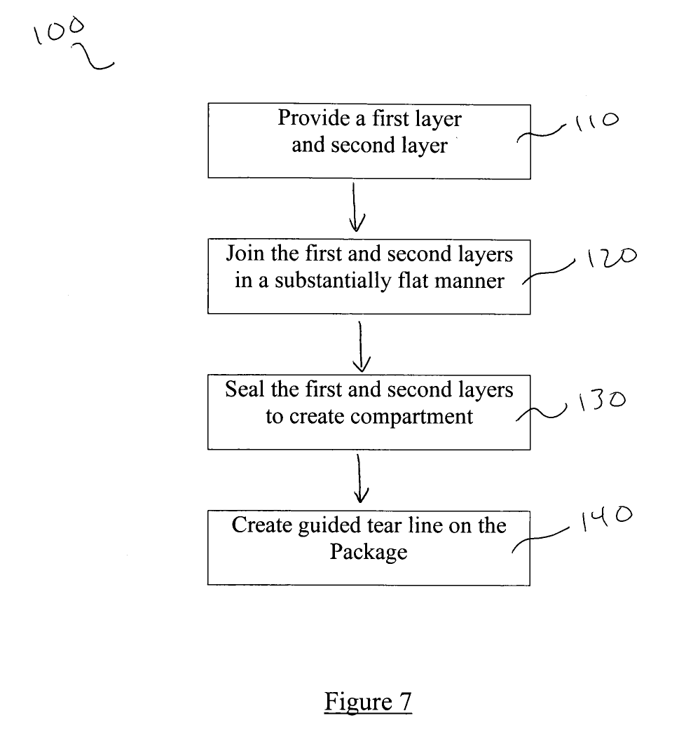

A method of forming the inventive package is provided herein. One embodiment of such a method 100 is provided by the flowchart of FIG. 7. In this method 100, a first layer 12 and a second layer 14 are provided in a first step 110. As explained above, desirably the first layer 12 and the second layer 14 are multi-layered materials, with a protective first and second inner layer 22, 24, and a first and second outer layer 20, 26. Each of the layers may have printing or other indicia thereon at this stage, or they may be blank.

Next, the step 120 of joining the first and second layers 12, 14 is provided. Again, as explained above, the first and second layers 12, 14 are desirably joined together in a substantially flat manner, with their respective inner layers (22, 24) in communication with each other. Preferably, the dosage 40 is disposed between the first and second layers 12, 14, in substantially the center of the layers 12, 14. With the two layers 12, 14 joined together, and the dosage 40 disposed between the two, the first and second layers 12, 14 may be sealed at the sealing area 32 (step 130). Desirably, the sealing area 32 extends about the periphery of the first and second layers 12, 14, such that a compartment 34 is created in substantially the middle of the package 10. The dosage 40 between the layers is housed in the compartment 34 created by the sealing area 32. The sealing step 130 may include any sealing methods desired, including but not limited to chemical sealing, pressure sealing, thermal sealing, ultrasonic sealing, UV sealing, Infrared sealing and combinations thereof. In one embodiment, the seal is created through a combination of thermal and pressure sealing. For example, the sealing area 32 may be subject to pressure of about 60 psi and a temperature of about 325° F. for a sufficient time to form a seal (such as about 1 second). The surfaces of the inner layers 22, 24 may be treated prior to joining together so as to aid in forming a secure and effective seal.

Preferably, the step 140 of forming a guided tear line may be performed prior to the step 130 of sealing the first and second layers 12, 14. In this embodiment, the first and second layers 12, 14 are first provided (step 110), and then the step 140 of forming a guided tear line 30 may be performed on either the first layer 12, the second layer 14 or both layers 12, 14. It may be desirable to form the guided tear line 30 prior to joining the two layers 12, 14 together (step 120), so that there is no potential to compromise the dosage 40 during the formation of the guided tear line 30 (step 140).

If desired, the guided tear line 30 may be formed through the use of laser printing on at least one of the first and/or second layers 12, 14. The guided tear line 30 may be any desired condition, including but not limited to a series of weakened areas 50 extending along at least a portion of at least one edge of the package 10. The guided tear line 30 may be formed along a portion of a longitudinal edge 16 of the package 10, or it may be formed along a portion of a lateral edge 18 of the package 10. In some embodiments, the guided tear line 30 may include a first section that extends along a portion of a longitudinal edge 16 (and preferably along a majority of longitudinal edge 16) and may also include a second section (30′) that extends along a portion of a lateral edge 18 of the package 10 (and preferably along a majority of lateral edge 18). The guided tear line 30 desirably extends at least partially into the compartment 34 of the package 10, in such a fashion that it does not interfere with the dosage 40 housed therein. With the package 10 sealed, the step 140 of forming the guided tear line 30 may be performed.

The use of a laser device to form the guided tear line 30 is especially beneficial in that the guided tear line 30 may be formed in only the outside layer(s) 20, 26 of the package 10, thereby preserving the integrity of the inside layer(s) 22, 24. As explained above, it is desirable that the inside layers 22, 24 be unharmed and unweakened, such that a safe and effective seal may be maintained in the compartment 34.

If desired, further printing of the package 10 may be performed, including placing writing, pictures, or other indicia on the package 10. The indicia may identify the contents of the package 10. Further, indicia may be provided that indicate the location(s) of the guided tear line 30 (and, if included, 30′). The location of the guided tear line 30 may, however, be evident to a user by simply viewing the package 10. Also, if desired, other features may be implemented into the package 10, such as a tear notch (including a fold-and-tear notch, as described above), which may aid in allowing the user to open the package 10. The guided tear line 30 may begin near or at one edge of the package 10 so as to act as a tear notch. In some embodiments, there may be more than one compartment 34 disposed in the package 10. In such embodiment, there may be a dosage 40 disposed in one or both of the compartments 34.

The completed package 10 may be provided to a user. When the user wishes to dispense the dosage 40 housed within the package 10, the user simply needs to tear along the guided tear line 30, revealing the dosage 40. Through the use of a guided tear line 30, the user may safely and easily open the package 10 without running the risk of tearing or otherwise compromising the dosage 40 contained therein.

It should be understood that various alternatives to the embodiments of the present invention described herein can be employed in practicing the present invention. While particular embodiments of the present invention have been described herein for purposes of illustration, many modifications and changes will become apparent to those skilled in the art. Accordingly, the claims set forth herein are intended to encompass all such modifications and changes as fall within the true spirit and scope of this invention.

1. A tearable package for a dosage form comprising:
(a) A first layer having a first inside layer and a first outside layer, said first inside layer comprising a first protective material and said first outside layer comprising a first laminate material;
(b) A second layer having a second inside layer and a second outside layer, said second inside layer comprising a second protective material and said second outside layer comprising a second laminate material; and
(c) A guided tear condition along a portion of at least one edge of said first outside layer; said first and second layers being overlaid with each other such that said first protective material and said second protective material are in contact and sealed together at a perimetrical sealing region, said fused layers defining a compartment there between for housing a dosage form.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A method of forming a tearable package containing a film dosage, comprising the steps of:
(a) Providing a first layer having a first inside layer and a first outside layer, said first inside layer comprising a first protective material and said first outside layer comprising a first laminate material, wherein said first inside layer and said first outside layer are laminated to each other;
(b) Providing a second layer having a second inside layer and a second outside layer, said second inside layer comprising a second protective material and said second outside layer comprising a second laminate material, wherein said second inside layer and said second outside layer are laminated to each other;
(c) Providing a dosage in the form of a substantially flat film;
(d) Overlaying said first and second layers with each other with said film dosage disposed therebetween, such that said first protective material and said second protective material are in communication with each other;
(e) Sealing said first and second layers together at a perimetrical sealing region, said sealed layers defining a compartment there between for housing said dosage form; and
(f) Forming a guided tear condition along a portion of at least one edge of said first outside layer, said guided tear condition being formed in said first outside layer of said laminated first layer without forming a guided tear condition in said first inside layer.

27. The method of claim 26, wherein said first protective material comprises a foil material.

28. The method of claim 26, wherein said second protective material comprises a foil material.

29. The method of claim 26, wherein said second protective material comprises a clear polymeric material.

30. The method of claim 26, wherein said first and second protective materials are the same material.

31. The method of claim 26, wherein said first and second protective materials are different materials.

32. The method of claim 26, wherein said first and second protective materials are capable of being sealed to each other.

33. The method of claim 26, wherein said first laminate material comprises plastic.

34. The method of claim 26, wherein said second laminate material comprises plastic.

35. (canceled)

36. The method of claim 26, wherein said compartment is sized to fit said substantially flat film.

37. The method of claim 26, wherein said guided tear condition extends into at least a portion of said compartment.

38. The method of claim 26, wherein said guided tear condition extends at least a portion of a length of a second edge of said first outside layer.

39. The method of claim 26, wherein said guided tear condition is selected from the group consisting of a series of perforations, indentations, deformations, scorings, and combinations thereof.

40. The method of claim 26, wherein said guided tear condition is disposed in the first outside layer, while first inside layer is free of said guided tear condition.

41. The method of claim 26, comprising a second guided tear condition extending along a portion of at least one edge of said second outside layer.

42. The method of claim 41, wherein said second guided tear condition is disposed in the second outside layer, while second inside layer is free of said second guided tear condition.

43. The method of claim 26, wherein said guided tear condition is formed via a laser.

44. The method of claim 26, wherein said first and second layers are sealed together in a non-peelable fashion.

45. The method of claim 26, wherein said package has at least one longitudinal edge and at least one lateral edge.

46. The method of claim 45, wherein said guided tear condition extends along a portion of said at least one longitudinal edge.

47. The method of claim 45, wherein said guided tear condition extends along a portion of said at least one lateral edge.

48. The method of claim 45, wherein said guided tear condition extends along a portion of said at least one longitudinal edge and along a portion of said at least one lateral edge.

49. The method of claim 48, wherein said guided tear condition is continuous along said at least one longitudinal edge and said at least one lateral edge.
